(19) United States
(12) Patent Application Publication
(10) Pub. No.: US 2026/0097508 A1
(43) Pub. Date: Apr. 9, 2026

(54) UNCERTAINTY-AWARE FAILURE DETECTION FOR IMITATION LEARNING ROBOT POLICIES

(71) Applicant: Toyota Research Institute, Inc., Los Altos, CA (US)

(72) Inventors: Chen Xu, Atlanta, GA (US); Robert Lee, Tokyo (JP); Paarth Shah, Houston, TX (US); Rares A. Ambrus, San Francisco, CA (US); Haruki Nishimura, Sunnyvale, CA (US); Mikhal Itkina, Palo Alto, CA (US)

(73) Assignees: Toyota Research Institute, Inc., Los Altos, CA (US); Toyota Jidosha Kabushiki Kaisha, Toyota-shi (JP)

(21) Appl. No.: 19/189,531

(22) Filed: Apr. 25, 2025

Related U.S. Application Data
(60) Provisional application No. 63/704,863, filed on Oct. 8, 2024.
(60) Provisional application No. 63/752,248, filed on Jan. 31, 2025.

(51) Int. Cl. B25J 9/16

(52) U.S. Cl. CPC B25J 9/1674; B25J 9/1653

(57) ABSTRACT

Systems and methods described herein relate to generating a discrimination scores set based on observation data and action data obtained from a robot trained to perform a task, determining a threshold value based on the discrimination score set, and comparing a discrimination score obtained while the task is being performed with the threshold value to determine if a failure condition is present. This may be performed by utilizing random network distillation or other out-of-distribution detectors and conformal band prediction computed on a set of successful rollouts by the robot.

### CROSS-REFERENCE TO RELATED APPLICATIONS

This application is based upon and claims the benefit of priority of U.S. Provisional Application No. 63/704,863, filed on Oct. 8, 2024, and U.S. Provisional Application No. 63/752,248, filed on Jan. 31, 2025, the entire contents of which are incorporated herein by reference.

### TECHNICAL FIELD

The subject matter described herein relates, in general, to strategies for failure detection for imitation learning robot policies.

### BACKGROUND

Recent years have witnessed impressive robotic manipulation systems driven by advances in imitation learning and generative modeling, such as diffusion- and flow-based approaches. These systems can fail due to suboptimality, inconsistency of stochastic actions, or unfavorable out-of-distribution operating conditions.

### SUMMARY

In one embodiment, a robot management system is disclosed. The robot management system includes one or more processors and a memory communicably coupled to the one or more processors. The memory stores a command module including instructions that when executed by the one or more processors cause the one or more processors to generate a discrimination scores set based on observation data and action data obtained from a robot trained to perform a task, determine a threshold value based on the discrimination score set, and compare a discrimination score obtained while the task is being performed with the threshold value to determine if a failure condition is present.

In one embodiment, a non-transitory computer-readable medium including instructions that when executed by one or more processors cause the one or more processors to generate a discrimination scores set based on observation data and action data obtained from a robot trained to perform a task, determine a threshold value based on the discrimination score set, and compare a discrimination score obtained while the task is being performed with the threshold value to determine if a failure condition is present.

In one embodiment, a method is disclosed. In one embodiment, the method includes generating a discrimination scores set based on observation data and action data obtained from a robot trained to perform a task, determining a threshold value based on the discrimination score set, and comparing a discrimination score obtained while the task is being performed with the threshold value to determine if a failure condition is present.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a robot within which systems and methods disclosed herein may be implemented.

FIG. 2 illustrates one embodiment of a failure detection system that is associated with uncertainty-aware failure detection strategies.

FIGS. 3A-E illustrates one embodiment of an imitation learning task.

FIG. 4 illustrates one example of a method for uncertainty-aware failure detection strategies.

### DETAILED DESCRIPTION

With respect to robotics, imitation learning may allow for the training of a robot, such that explicit and tedious programming of a task by a human user may be minimized or eliminated. However, imitation learning can fail due to poor stochastic sampling, such as where a model may encounter out-of-distribution (OOD) conditions where the input observations deviate significantly from the training data distribution. As another example, a mismatch in the commanded and executed actions of the robot due to the difficulty of the task may cause a policy to fail. In such cases, the generated actions may be unreliable or even dangerous. Therefore, it is advantageous to detect these failures as quickly as possible to ensure the safety and reliability of the robotic system.

In view of the observations made by a robot and the actions the robot generates to perform a task based on those observations, discrimination scores indicative of task success or failure may be generated. Once these discrimination scores are generated, they may then be compared with thresholds obtained by methods such as conformal band prediction. In this manner, if a discrimination score falls outside such a threshold, a robot may be able to determine that an action has led to a failure condition. When a failure condition is detected, a remedial action may then be taken to avoid the possibility of failure, such as instructing the robot to let a human operator complete the task. Another aspect is that a benefit of the failure detection pipeline disclosed herein is that to learn discrimination scores may be performed without reliance on failure data that is typically not available in imitation learning data sets.

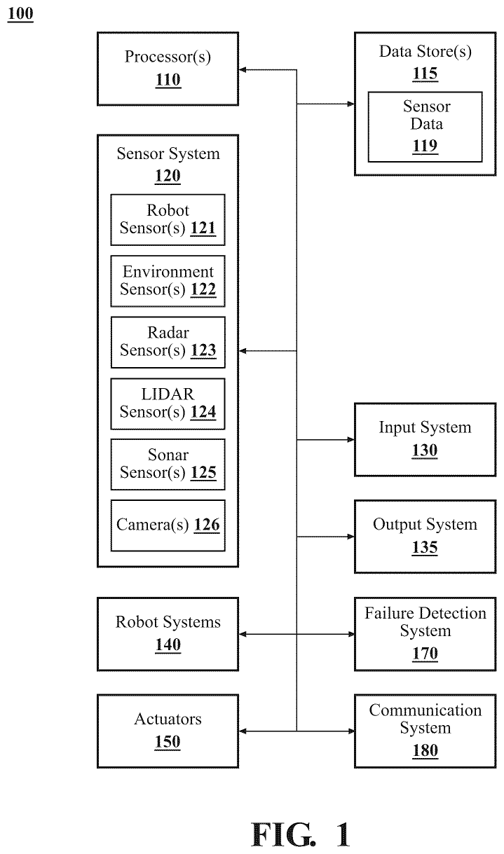

Referring to FIG. 1, an example of a robot 100 is illustrated. As used herein, a “robot” is any form of a programmable machine capable of sensing its environment, processing information, and performing tasks autonomously or semi-autonomously. In one or more implementations, robot 100 is a robotic manipulator (e.g., a robotic arm). While arrangements will be described herein with respect to robotic manipulators, it will be understood that embodiments are not limited to robotic manipulators. In some implementations, robot 100 may be any robotic device or form of motorized vehicle that, for example, includes sensors to perceive aspects of the surrounding environment, and thus benefits from the functionality discussed herein associated with uncertainty-aware failure detection strategies.

Robot 100 also includes various elements. It will be understood that in various embodiments it may not be necessary for robot 100 to have all of the elements shown in FIG. 1. Robot 100 may have any combination of the various elements shown in FIG. 1. Further, robot 100 may have additional elements to those shown in FIG. 1. In some arrangements, robot 100 may be implemented without one or more of the elements shown in FIG. 1. While the various elements are shown as being located within robot 100 in FIG. 1, it will be understood that one or more of these elements may be located external to robot 100. Further, the elements shown may be physically separated by large distances. For example, as discussed, one or more components of the disclosed system may be implemented within a robot while further components of the system are implemented within a cloud-computing environment or other system that is remote from robot 100.

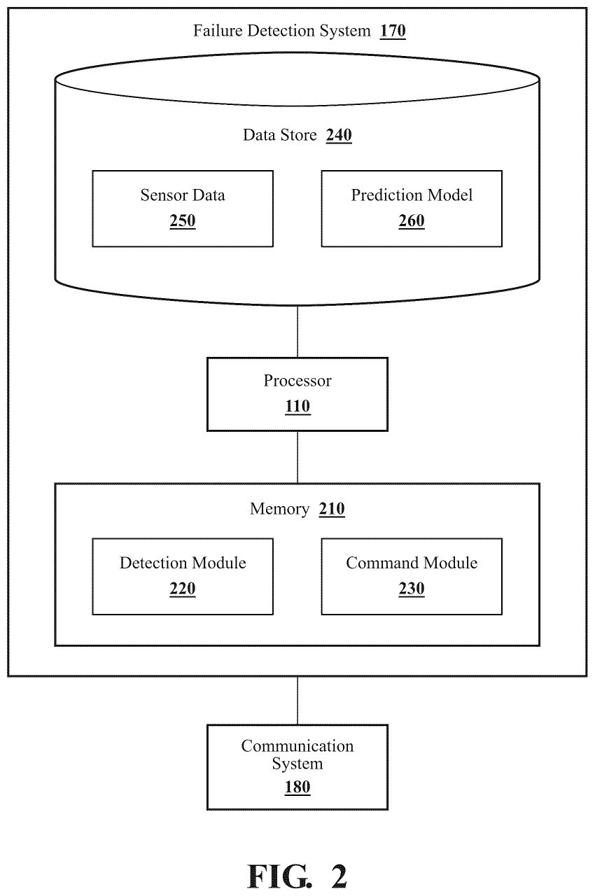

Some of the possible elements of robot 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, robot 100 includes a failure detection system 170 that is implemented to perform methods and other functions as disclosed herein relating to uncertainty-aware failure detection. As will be discussed in greater detail subsequently, failure detection system 170, in various embodiments, is implemented partially within robot 100 and as a cloud-based service. For example, in one approach, functionality associated with at least one module of failure detection system 170 is implemented within robot 100 while further functionality is implemented within a cloud-based computing system.

With reference to FIG. 2, one embodiment of failure detection system 170 of FIG. 1 is further illustrated. Failure detection system 170 is shown as including processor(s) 110 from robot 100 of FIG. 1. Accordingly, processor(s) 110 may be a part of failure detection system 170, failure detection system 170 may include a separate processor from processor 110(s) of robot 100, or failure detection system 170 may access processor 110(s) through a data bus or another communication path. In one embodiment, failure detection system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processor(s) 110 cause processor(s) 110 to perform the various functions disclosed herein.

Failure detection system 170 as illustrated in FIG. 2 is generally an abstracted form of failure detection system 170 as may be implemented between robot 100 and a cloud-computing environment. Accordingly, failure detection system 170 may be embodied at least in part within a cloud-computing environment to perform the methods described herein.

With reference to FIG. 2, detection module 220 generally includes instructions that function to control processor(s) 110 to receive data inputs from one or more sensors of robot 100. The inputs are, in one embodiment, observations of one or more objects in an environment proximate to robot 100, other aspects about the surroundings, or both. As provided for herein, detection module 220, in one embodiment, acquires sensor data 250 that includes at least camera images. In further arrangements, detection module 220 acquires sensor data 250 from further sensors such as contact sensors and other sensors as may be suitable for identifying objects, locations of the objects, orientation of objects, effector contact with objects, and so on.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within robot 100. Moreover, detection module 220 may undertake various approaches to fuse data from multiple sensors when providing sensor data 250, such as sensor data acquired over a wireless communication link. Thus, sensor data 250, in one embodiment, represents a combination of perceptions acquired from multiple sensors.

In addition to locations of surrounding objects, sensor data 250 may also include, for example, effector pose commands, contact states, detected marker poses, etc. Moreover, detection module 220, in one embodiment, controls the sensors to acquire sensor data about an area that encompasses 360 degrees about robot 100, which may then be stored in sensor data 250. In some embodiments, such area sensor data may be used to provide a comprehensive assessment of the surrounding environment around robot 100. Of course, in alternative embodiments, detection module 220 may acquire the sensor data about a forward direction alone when, for example, robot 100 is not equipped with further sensors to include additional regions about the robot or the additional regions are not scanned due to other reasons (e.g., unnecessary due to known current conditions).

Moreover, in one embodiment, failure detection system 170 includes a database 240. Database 240 is, in one embodiment, an electronic data structure stored in memory 210 or another data store and that is configured with routines that may be executed by processor(s) 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when sensor data 250 was generated, and so on.

Detection module 220, in one embodiment, is further configured to perform additional tasks beyond controlling the respective sensors to acquire and provide sensor data 250. For example, detection module 220 includes instructions that may cause processor(s) 110 to obtain observations Oₜ as described herein. In some embodiments, detection module 220 may receive and store observations Oₜ.

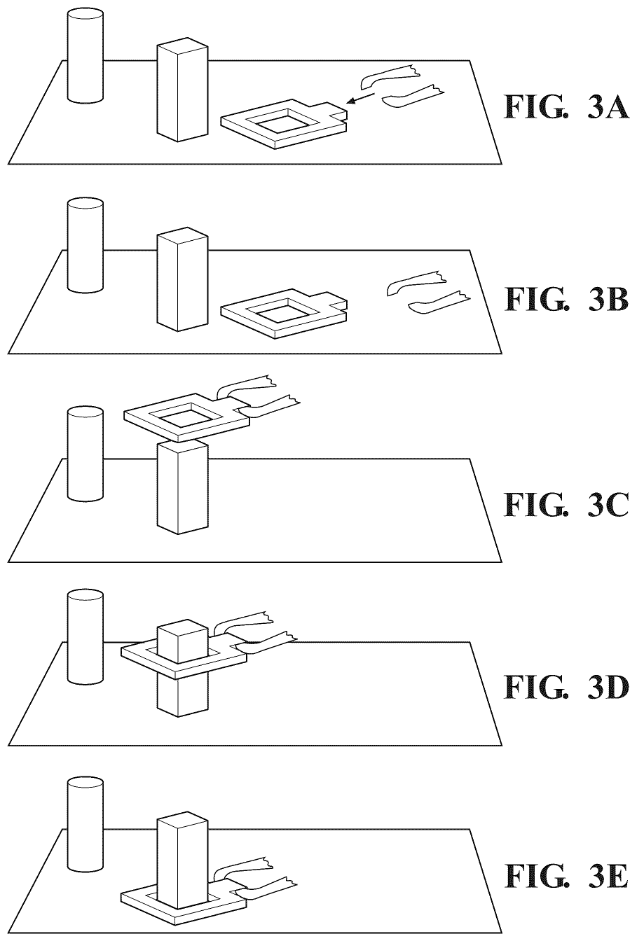

For example, as shown in FIGS. 3A-E, an example of a task for a robot is shown where an agent picks up a square by a tab and then places it around a square-shaped column. A number of recordings may be made of the agent performing the task. The agent may not perform the task the same every time. Further, the agent need not be human, but may instead be another robot, an animal, a mechanical contrivance, etc. Each recording of the task being performed may be considered to demonstrate a success trajectory if the task is completed successfully. Similarly, each recording of the task being performed may be considered to demonstrate a failure trajectory if the task is not completed successfully. Collectively, the success trajectories, failure trajectories, or both may be used to create a training set composed of observation data Oₜ and actions Aₜ.

Observation data Oₜ may contain not only images of the task being performed, but also contact states, detected marker poses, etc. In some embodiments, robot 100 may generate observation data Oₜ based on sensor data 250 (e.g., as obtained from the sensors of robot 100). In some embodiments, robot 100 may receive observation data Oₜ from other observers (e.g., via a cloud network from another robot that observed the agent). Actions Aₜ may be obtained for example from instructions that caused the robot to perform a task, such as joint space commands, Cartesian-space commands, task-space commands, sensor-based commands, programming commands, effector pose commands, etc.

Once such a training set is created (e.g., by command module 230 denoting a set of success trajectories as a training set), a policy may be generated by command module 230 based on observation data Oₜ and actions Aₜ within the training set. For example, a denoising diffusion probabilistic model (DDPM) may be used by command module 230 to approximate the conditional distribution p(Aₜ|Oₜ). A DDPM implemented by command module 230 may start from Aₜ^{k} sampled from Gaussian noise and then perform K iterations of denoising to produce a series of intermediate actions with decreasing levels of noise,

$${A}_{t}^{k} , {A}_{t}^{k - 1} , … , {A}_{t}^{0} ,$$

until a desired noise-free output Aₜ⁰ is formed, using the following approach:

$${A}_{t}^{k - 1} = α ( {A}_{t}^{k} - γ {ε}_{θ} ( {O}_{t} , {A}_{t}^{k} , k ) + 𝒩 ( 0 , {σ}^{2} I ) ) , \qquad Equation ( 1 )$$

where ε_{θ} is the noise prediction network with parameters e that will be optimized through learning and [symbol] (0, σ₂I) is Gaussian noise added at each iteration. The choice of α, γ, σ as functions of iteration step k, also called noise schedule, may be determined by the command module 230 via a cosine schedule or other approaches.

Command module 230 may then begin the training process by randomly drawing unmodified examples,

$${A}_{t}^{0} ,$$

from the dataset. For each sample, the training process conducted by command module may randomly select a denoising iteration k and then sample a random noise ε^{k} for iteration k. A noise prediction network may then be used by command module 230 to predict the noise from the data sample with noise added so that the following training loss function can be minimized:

$$ℒ = MSE ( {ε}^{k} , {ε}_{θ} ( {O}_{t} , {A}_{t}^{0} + {ε}^{k} , k ) ) . \qquad Equation ( 2 )$$

The noise prediction network ε_{θ} may be constructed by command module 230 with convolutional neural networks (CNN), a time-series diffusion transformer, etc.

As another example of generating a policy from a training set, command module 230 may utilize a flow-matching approach. For example, the training of the flow matching may be defined as follows:

$${a}^{s r c} ∼ {ρ}^{s r c} , {a}^{d s t} ∼ {ρ}^{d s t} , t ∼ 𝒰 [ 0 , 1 ] , {𝓏}_{t} = ( 1 - t ) {a}^{s r c} + t {a}^{d s t} , {ℒ}_{flow} = {𝔼}_{{a}^{s r c} , {a}^{d s t} , t} {‖ f ( {𝓏}_{t} , t , s ) - ( {a}^{d s t} - {a}^{s r c} ) ‖}^{2} , \qquad Equation ( 3 )$$

where ρ^{src} is the source distribution, chosen as a multivariate normal distribution ρ^{src}= [symbol] (0, I), ρ^{dst} is the destination distribution (here the demonstration trajectories), a^{src} and a^{dst} are the trajectories sampled from source and destination distributions, t∈ [symbol] is the scalar flow transport time uniformly sampled between 0 and 1 representing the progression of the transformation from source to destination, s is the input state associated to the command trajectory a^{dst}, zₜ is the interpolated trajectory at transport time step t between source and destination trajectories, [symbol] _{flow}∈ [symbol] is the scalar training loss function. ƒ is the flow model conditioned by the state s such that:

$$Flow f : 𝓏 , t , s \to Δ𝓏 . \qquad Equation ( 4 )$$

Equation (4) may be implemented as a neural network and trained using backpropagation minimizing the loss [symbol] _{flow}.

Once the training is complete, command module 230 may then generate actions Aₜ based on observations Oₜ (e.g., by using a diffusion policy or flow-matching policy as described above). For example, Oₜ may be comprised of visual embeddings of images and non-visual information (e.g., robot/gripper position), which for a trajectory may result in predicted actions Aₜ that a robotic motion controller is programmed to implement.

In implementing the actions Aₜ, disturbances within the environment or other environmental factors may affect the results of actions Aₜ. For example, disturbances that may affect camera position (e.g., vehicle traffic, nearby construction, wind) or unexpected objects not observed within the training set may affect the outcome of actions Aₜ. While the policies described herein (e.g., DDPM) may seek to optimize actions Aₜ in the presence of such factors to achieve a successful outcome, such a policy by itself does not provide a measure or statistical guarantee to command module 230 of whether the actions Aₜ will likely lead to a successful outcome.

Accordingly, in some embodiments, a failure detection module 260 may be trained by command module 230 based on actions Aₜ and observations Oₜ to provide a score D_{M} as follows:

$${D}_{M} = m ( {A}_{t} , {O}_{t} ; θ ) , \qquad Equation ( 5 )$$

where m is a method for determining a discrimination score such as a probabilistic approach (e.g., logpO, logpZO), a second-order distribution approach (e.g., Natural Posterior Network (NatPN), Deep Evidential Regression (DER)), a discrimination approach (e.g., (Random Network Distillation (RND)), a post-hoc approach (e.g., SPectral ARC length (SPARC)), etc; and θ are any parameters (e.g., neural network parameters) used to implement the method m.

For example, given a training set D_{τ} (e.g., a set of successful trajectories) and a randomly initialized network φ, the RND approach seeks to minimize the distance between a predictor network ƒ(⋅; φ) and a target network ƒ_{T} (⋅) over D_{τ} by optimizing the predictor network. An optimal predictor network may be obtained for (Aₜ, Oₜ)˜D_{τ} as follows:

$${ϕ}^{*} = arg {min}_{ϕ} {D}_{M} ( {A}_{t} , {O}_{t} , ϕ ) , where \qquad Equation ( 6 )$$

$${D}_{M} ( {A}_{t} , {O}_{t} , ϕ ) = {‖ {f}_{T} ( {A}_{t} , {O}_{t} ) - f ( {A}_{t} , {O}_{t} , ϕ ) ‖}_{2}^{2} . \qquad Equation ( 7 )$$

Once the optimal predictor is obtained, for in-distribution samples the RND approach typically yields low discrimination scores, while out-of-distribution samples typically yield high discrimination scores.

In some embodiments, command module 230 may determine if a failure condition has been detected based on comparison of a discrimination score with a threshold (e.g., D_{M}>C_{α}). For example, conformal prediction bands for setting the value of a threshold may be generated based on the optimal predictor network described above for (Aₜ, Oₜ)˜D_{τ} as follows. First, after command module 230 performs Nₛ successful rollouts (e.g., using a diffusion or flow-matching policy) for T time steps each, command module 230 may calculate calibration scores D_{M} (Aₜⁱ, Oₜⁱ; θ) for each rollout i=1, . . . , N_{S}.

Thereafter, command module 230 may then select two sizes N₁ and N₂ such that N₁+N₂≤Nₛ. For instance, if Nₛ equals 100 then command module 230 may select values of N₁ and N₂ of 30 and 70, respectively. After selecting values for N₁ and N₂, command module 230 may select N₁ calibration scores from N₁ rollouts to form calibration set D_{cal}_{_{A}} and select N₂ calibration scores from N₂ rollouts to form calibration set D_{cal}_{_{B}}. The manner of selection by command module 230 in forming calibration sets D_{cal}_{_{A}} and D_{cal}_{_{B}} may be sequential, random, pre-determined by user instructions, etc.

After obtaining D_{cal}_{_{A}} and D_{cal}_{_{B}}, command module 230 may calculate a mean successful trajectory μₜ as follows:

$${μ}_{t} = {N}_{1}^{- 1} {\sum }_{i = 1}^{{N}_{1}} {D}_{M} ( {A}_{t}^{i} , {O}_{t}^{i} ; θ ) for t = 1 , … , T on {D}_{c a {l}_{A}} , \qquad Equation ( 8 )$$

and a maximum deviation Dⱼ as follows:

$${D}_{j} = {max}_{j = 1 , … , {N}_{2}} ( {\{ {μ}_{t} - {D}_{M} ( {A}_{t}^{j} , {O}_{t} ; θ ) \}}_{t = 1}^{T} ) on {D}_{c a {l}_{B}} \qquad Equation ( 9 )$$

Upon determining maximum deviation Dⱼ for D_{cal}_{_{B}}, command module 230 may then create the ordered set S as follows:

$$S = ( {D}_{j} , \leq ) for j = 1 , … , {N}_{2} . \qquad Equation ( 10 )$$

Upon receiving ordered set S, command module 230 may then use the parameter α to select the (1−α) quantile of S to obtain the bandwidth h and obtain a threshold upper bound as follows:

$${upper}_{t} = {μ}_{t} + h for t = 1 , … , T \qquad Equation ( 11 )$$

Based upon a threshold upper bound, command module 230 may then determine if a discrimination score for a rollout being performed is above the threshold as follows:

$${D}_{M} ( {A}_{t} , {O}_{t} ) > {upper}_{t} , \qquad Equation ( 12 )$$

where Equation (12) if true results in a rollout being deemed as satisfying a failure condition (e.g., because it may be seen as being out-of-distribution). In some embodiments, command module 230 may deem a rollout to satisfy a failure condition if Equation (12) is true for any t∈{1, . . . , T} (e.g., the first instance of t where Equation (12) is true as time progresses). In some embodiments, command module 230 may deem a rollout to satisfy a failure condition if Equation (12) is true for two or more instances of t∈{1, . . . , T}.

In various embodiments, when a failure condition is determined to be present, command module 230 may perform or instruct to be performed a recovery action. For example, a recovery action may be sending a notification that a failure has been detected; ceasing to perform a task; restarting a task; triggering additional logging of sensor observations or robot commands; causing the robot to implement a different policy (e.g., switching from a diffusion-based policy to a flow-matching policy or vice versa; switching to a non-generative policy); instructing the robot to proceed to a safe state; etc.

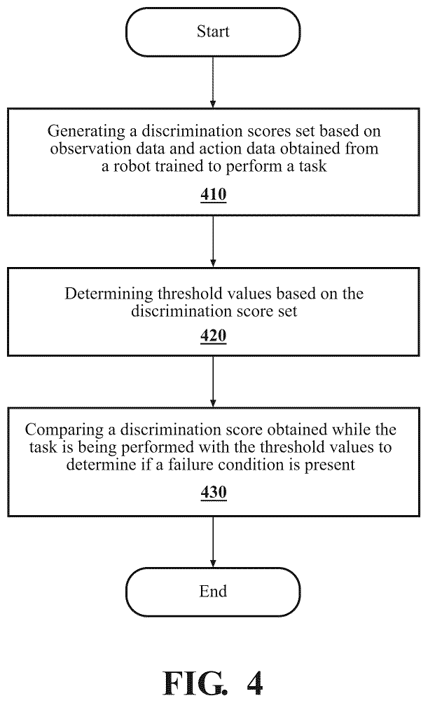

FIG. 4 illustrates a flowchart of a method 400 that is associated with using uncertainty-aware failure detection strategies. Method 400 will be discussed from the perspective of the failure detection system 170 of FIGS. 1 and 2. While method 400 is discussed in combination with the failure detection system 170, it should be appreciated that the method 400 is not limited to being implemented within failure detection system 170 but is instead one example of a system that may implement method 400.

At step 410, command module 230 may generate a discrimination scores set based on observation data and action data obtained from a robot trained to perform a task. For example, a training set composed only of successful trajectories may be used to generate a diffusion-based policy or a flow-matching policy. Once such a policy is generated, command module 230 may then perform a series of rollouts. Calibration data collected during a set of those rollouts (e.g., only successful ones) may then be used to determine the discrimination scores set, such as by using a discrimination approach (e.g., RND).

At step 420, command module 230 may determine a threshold value based on the discrimination score set. For example, a threshold value may be determined by command module 230 utilizing conformal prediction bands as described herein.

At step 430, command module 230 may compare a discrimination score obtained while the task is being performed with the threshold value to determine if a failure condition is present.

For example, if a discrimination score falls outside a threshold (e.g., upperₜ), a failure condition may be determined to have occurred by command module 230. In some embodiments, a failure condition may only be determined to have occurred by command module 230 if multiple discrimination scores are determined to be above the threshold.

FIG. 1 will now be discussed in full detail as an example environment within which the system and methods disclosed herein may operate.

Robot 100 may include one or more processor(s) 110. In one or more arrangements, processor(s) 110 may be a main processor of robot 100. For instance, processor(s) 110 may be an electronic control unit (ECU). Robot 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

Data store(s) 115 may include sensor data 119. In this context, “sensor data” means any information about the sensors that robot 100 is equipped with, including the capabilities and other information about such sensors. As will be explained below, robot 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of sensor data 119 may be located in data stores(s) 115 located onboard robot 100. Alternatively, or in addition, at least a portion of sensor data 119 may be located in data stores(s) 115 that are located remotely from robot 100.

As noted above, robot 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of robot 100 (including any of the elements shown in FIG. 1), or any combination thereof. Sensor system 120 may acquire data of at least a portion of the external environment of robot 100 (e.g., nearby objects).

Sensor system 120 may include any suitable type of sensor. Various examples of different types of sensors will be described herein. However, it will be understood that the embodiments are not limited to the particular sensors described. Sensor system 120 may include one or more robot sensor(s) 121. Robot sensor(s) 121 may detect, determine, sense, or acquire in a combination thereof information about robot 100 itself. In one or more arrangements, robot sensor(s) 121 may be configured to detect, sense, or acquire in a combination thereof position and orientation changes of robot 100, such as, for example, based on inertial acceleration. In one or more arrangements, robot sensor(s) 121 may include one or more accelerometers, one or more gyroscopes, one or more position sensors, one or more force and torque sensors, one or more tactile sensors, one or more proximity sensors, vision sensors, pressure sensors, temperature sensors, inertial measurement units (IM Us), gripper sensors, other suitable sensors, or any combination thereof. Robot sensor(s) 121 may be configured to detect, sense, or acquire in a combination thereof one or more characteristics of robot 100.

Alternatively, or in addition, sensor system 120 may include one or more environment sensor(s) 122 configured to acquire, sense, or acquire in a combination thereof robot environment data. “Robot environment data” includes data or information about the external environment in which a robot is located or one or more portions thereof. For example, environment sensor(s) 122 may be configured to detect, quantify, sense, or acquire in any combination thereof obstacles in at least a portion of the external environment of robot 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of robot 100, such as, for example, pose markers, signs, lights, etc.

Various examples of sensors of sensor system 120 will be described herein. The example sensors may be part of the one or more environment sensor(s) 122, the one or more robot sensor(s) 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more camera(s) 126, or any combination thereof. In one or more arrangements, camera(s) 126 may be high dynamic range (HDR) cameras or infrared (IR) cameras.

Robot 100 may include an input system 130. An “input system” includes any device, component, system, element or arrangement or groups thereof that enable information/data to be entered into a machine. Input system 130 may receive an input from a user (e.g., a robot operator). Robot 100 may include an output system 135. An “output system” includes any device, component, or arrangement or groups thereof that enable information/data to be presented to a user (e.g., a robot operator).

Robot 100 may include one or more robot system(s) 140. Various examples of robot system(s) 140 are shown in FIG. 1. However, robot 100 may include more, fewer, or different robot systems. It should be appreciated that although particular robot systems are separately defined, each or any of the systems or portions thereof may be otherwise combined or segregated via hardware, software, or a combination thereof within robot 100. Each of these systems may include one or more devices, components, or combinations thereof, now known or later developed.

Robot 100 may include one or more actuator(s) 150. Actuator(s) 150 may be any element or combination of elements operable to modify, adjust, alter, or in any combination thereof one or more of robot system(s) 140 or components thereof to responsive to receiving signals or other inputs from processor(s) 110. Any suitable actuator may be used. For instance, actuator(s) 150 may include motors, pneumatic actuators, hydraulic pistons, relays, solenoids, and piezoelectric actuators, just to name a few possibilities.

Robot 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
generate a discrimination scores set based on observation data and action data obtained from a robot trained to perform a task;
determine a threshold value based on the discrimination score set; and
compare a discrimination score obtained while the task is being performed with the threshold value to determine if a failure condition is present.

2. The system of claim 1, wherein the machine-readable instruction to generate the discrimination scores set is based only on the observation data and the action data from successful rollouts.

3. The system of claim 1, wherein the machine-readable instruction to generate the discrimination scores set utilizes random network distillation.

4. The system of claim 1, wherein the machine-readable instruction to determine the threshold value utilizes conformal band prediction.

5. The system of claim 1, wherein the machine-readable instructions further include to instruct the robot to perform a recovery action if the failure condition is present.

6. The system of claim 1, wherein the machine-readable instruction to generate the discrimination scores set utilizes a probabilistic approach.

7. The system of claim 5, wherein the machine-readable instruction to perform the recovery action involves selecting a new policy.

8. A non-transitory computer-readable medium including instructions that when executed by one or more processors cause the one or more processors to:
generate a discrimination scores set based on observation data and action data obtained from a robot trained to perform a task;
determine a threshold value based on the discrimination score set; and
compare a discrimination score obtained while the task is being performed with the threshold value to determine if a failure condition is present.

9. The non-transitory computer-readable medium of claim 8, wherein the instruction to generate the discrimination scores set is based only on the observation data and the action data from successful rollouts.

10. The non-transitory computer-readable medium of claim 8, wherein the instruction to generate the discrimination scores set utilizes random network distillation.

11. The non-transitory computer-readable medium of claim 8, wherein the instruction to determine the threshold value utilizes conformal band prediction.

12. The non-transitory computer-readable medium of claim 8, wherein the instructions further include to instruct the robot to perform a recovery action if the failure condition is present.

13. The non-transitory computer-readable medium of claim 8, wherein the instruction to generate the discrimination scores set utilizes a probabilistic approach.

14. A method, comprising:
generating a discrimination scores set based on observation data and action data obtained from a robot trained to perform a task;
determining a threshold value based on the discrimination score set; and
comparing a discrimination score obtained while the task is being performed with the threshold value to determine if a failure condition is present.

15. The method of claim 14, wherein generating the discrimination scores set is based only on the observation data and the action data from successful rollouts.

16. The method of claim 14, wherein generating the discrimination scores set utilizes random network distillation.

17. The method of claim 14, wherein determining the threshold value utilizes conformal band prediction.

18. The method of claim 14, further comprising instructing the robot to perform a recovery action if the failure condition is present.

19. The method of claim 14, wherein generating the discrimination scores set utilizes a probabilistic approach.

20. The method of claim 18, wherein instructing the robot to perform the recovery action involves selecting a new policy.
